(19) United States
(12) Patent Application Publication
(10) Pub. No.: US 2005/0209949 A1
(43) Pub. Date: Sep. 22, 2005

(54) System and method for stock option accounting

(76) Inventor: Louis P. Le Guyader, East Islip, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 11/086,034

(22) Filed: Mar. 22, 2005

Related U.S. Application Data
(60) Provisional application No. 60/555,105, filed on Mar. 22, 2004.

(51) Int. Cl. G06F 17/60

(52) U.S. Cl. 705/36

(57) ABSTRACT

A system and method for providing an alternative model for accounting for stock options. A Strike Value Account is created on a Balance Sheet. User-selectable inputs are provided for indicating whether a Strike Value of the stock option is to be recorded on a balance sheet, whether the Fair Value of the stock options is to be equal to Market Value, whether to update a Carrying Amount of the stock options periodically, whether to keep the Strike Value Account on the Balance Sheet at all times, whether the Intrinsic Value of said options are to be expensed in Earnings, and whether options carried as Fair Value are to be expensed through Earnings. The present invention provides a more accurate assessment of and accounting for stock options via, e.g., the consideration of Strike Values and Intrinsic Values of the stock options.

The present application claims priority from U.S. Provisional Application Ser. No. 60/555,105 entitled, “Stock Option Proxy Contract—a method of accounting for stock options,” filed on Mar. 22, 2004.

### BACKGROUND OF THE INVENTION

1. Technical Field

The present invention relates generally to stock option accounting and more specifically, to a system and method for providing an alternative accounting model for accounting for stock options.

2. Description of the Related Art

I. Financial Accounting of Employee Stock Options

I.A. Description of Employee Stock Options Compensation

Generally, employee stock options (“ESO's”) give an employee the right but not the obligation to purchase a stated number of shares of the employing company's stock for a stated price (the “strike price”) during a specified period of time (the “exercise period”). ESO's have emerged as a significant component of compensation for many U.S. companies and are basically call options that are given to employees. The valuation of ESO's is important to companies for a number of reasons, including the accurate reporting of labor costs and for designing effective compensation programs.

I.B. ESO Compensation Motivates Need for ESO Accounting

There is general agreement that ESOs can give rise to extraordinary compensation levels. ESO compensation schemes have proven especially controversial in settings where accounting is manipulated and so share prices are incorrect since ESO compensation are indexed to share prices.

An improved accounting model for ESOs would permit the accounting community to answer the question “How much is being paid to employees?” in a more transparent way.

Accounting for ESOs is controversial. It is controversial both because of the underlying behavior, compensation practices, and the nature and technical attributes of the proposed accounting for this behavior.

In fact, the financial accounting for ESOs is one of the most vexing problems to accounting regulators in the United States. The preference of most accounting regulators is that compensation costs should be accurately measured and recognized in the financial statements at the earliest appropriate time. Until recently ESOs have generally been carried “off balance sheet”. As a result the regulatory community, in particular, has taken the position that the part of employees' compensation represented by the exercise of ESOs is (1) not reported transparently, (2) not properly signaled in the GAAP accounting system that prevailed through the late 1990s and (3) always a late surprise when the compensation is eventually reported.

The ESO accounting in GAAP has been considered deficient up until late 2005 because there is no requirement to place ESOs in the financial statements of issuing entities. Without financial statement recognition, compensation earned under ESOs always appears to be an accounting surprise. In essence, there is nothing in the accounts that helps an informed reader estimate the ESO compensation until the contracts are exercised.

I.B.2. The Regulatory Setting for ESO Accounting in 2005

The ESO accounting controversy is complicated and aggravated by many contemporaneous changes in the GAAP accounting model since 1990: on balance recognition of retirement items, recognition of pollution liabilities, and the introduction of fair value accounting for financial instruments with particular emphasis on derivatives. These changes have proven to be economically and legally significant: more than 25% or reported equity in all public companies was wiped out when retirement accounting was activated; major industrial companies have filed for bankruptcy due to the weight of superfund liabilities alone; a company with over # 1 trillion in assets was found to have a material capital deficiency by its regulator because it accounted for derivatives incorrectly.

Most of the public ESO accounting controversy is centered on the central question of whether the cost of ESOs should be recorded in the Income Statement as an Expense, or a reduction in Earnings. Proponents of this approach support the position that since ESOs represent compensation costs, the most transparent way to report the cost is in Earnings.

That focus, ESO expensing, has resulted in an incomplete and possibly erroneous accounting solution that is a mandatory component of GAAP in later 2005 under FAS123r.

I.C. Attributes of the Accounting Model that are Relevant to ESO Accounting

The solution of “ESO expensing” represents only part of the solution needed, from a purely technical accounting perspective: Expensing implies a “debit” entry that requires an equal an opposite, or “credit” entry; every accounting entry requires an accurate measurement or estimate of the accounting variable in question; and the progression of the entries through the expiration of the ESO contract must be specified.

“ESO expensing” has left many of these three items, and other items as well, unspeficied or specified in a manner that generates controversy, inconsistency or possible error.

I.C.1. A Summary of ESO Expensing Under US GAAP [1995-2005]

Almost all GAAP for ESOs is contained in the FASB document FAS123 in its various forms. There are three versions of this document that merit special consideration: FAS123 as published in 1995, the proposed revision published as an Exposure Draft in 2003, and the amended accounting rule FAS123r published in December 2004.

KEY Accounting Policies in GAAP
(For SEC Issuers with Publicly Traded Stock on which ESOs
are written only.)

| | FAS123 | EDFAS123r | FAS123r |
|---|---|---|---|
| Issue Date | 1995 | Mar. 25, 2004 | December 2004 |
| Effective Date | | N/A | late 2005^{♦} |
| ESO Expensing | Thru | Through | Through |
| | Earnings | Earnings | Earnings |
| Measurement | Fair Value | Fair Value | Fair Value |
| Balance Sheet | Unspecified | Unspecified | Liability |
| Recognition | | | |
| Remeasurement | NO | NO | NO |
| (Marking-to-Market) | | | |
| Accounts Cleared if No | Unspecified | Unspecified | NO |
| Exercise | | | |

This Provisional Patent Application was dated Mar. 22, 2004
^{♦}Earlier application was permitted. Approximately 30-50% of SEC reporting Public Entities (“SEC Issuers”) are early adopters of FAS123r.

ESO accounting has been contested during the deliberations of the FASB on all these issues and more. This chart underemphasizes the disproportionate amount of time during FASB deliberations spent on the two primary ESO accounting topics: ESO expensing and admissibility of measurement technique.

I.C.2. The Accounting Issues Associated With “ESO Expensing”

Accounting for ESOs raises many other controversial issues in addition to “ESO Expensing”.

Accounting solutions are designed to reflect not only the transaction or economic event in question but the underlying management behavior in question.

I.C.2.a. ESO is a Compound Derivative Comprised of a Forward Into an American Call Option

ESOs are but one type of option contract. The counterpart to the contract are the employer as the contract originator or writer, and the employee as the contract holder or intended beneficiary. ESOs have been difficult to comprehend because they are complex contracts: they are long-dated, or forward position in a call option that takes the form of an American call as of the vesting date and from the issuing entity's point of view is a short, or written, option position. The time line below provides a standard representation for a prototypical ESO.

[image]

The ESO exists with fixed terms as an enforceable contract as of the Grant Date. The contract vests on the Vesting Date. The period of time from the Grant Date to the Vesting Date is called the Vesting Period. The contract matures, or ceases to exist, on its Expiration Date. The Expiration date is also the Maturity Date of the option. The period from the Vesting Date to the Maturity Date is the Exercise Period.

The Vesting Date is taken as the first date when the ESO may be exercised. During the Vesting Period it may not be exercised. The ESO may be exercised on any date during the Exercise Period. Since it may be exercised on “any date” it is considered an “American” option. If it is exercised prior to the maturity of the ESO, the contract ceases to exist; as a result of this exercise feature the expected maturity of the contract may be a period of time equal to the period described as “between a date that is the same or earlier than the Maturity Date and the same or longer than the Vesting Date”.

The Strike Price, also known as the Exercise Price and the Black-Scholes variable “K”, is the price that the optionholder must pay to purchase a share of stock through the option contract instead of through an open market purchase.

While the contract may be exercised at any time during the Exercise Period, it is commonly accepted that exercise will only occur if the Market Price of the stock that is the “underlying item” in the option is more than the Strike Price in the option (that is, the option is “in the money”); “at the money” and “out of the money” options will almost surely mature and expire unexercised.

The issue following accounting issues have arisen in the course of the accounting deliberations on ESOs and they are not the subject of the alternative proposal contained in this submission: the date at which the ESO should be recognized in the financial statements: use of the Grant Date as the date the option contracts must first be recognized in the Balance Sheet, the use of the Strike Price as the Balance Sheet carrying value of the share that is transferred to the option holder upon exercise,

I.C.3. ESOs are “Written” Option Contracts

Recent SEC emphasis on the riskiness of options, and written options in particular have further motivated the accounting policy for ESO expensing.

Since the option is a written contract, the economic benefit from the contract can only flow to the option holder and is experienced as a cost by the option writer. Whether the cost is a current cost of business and so an expense, or an investment of another kind is one of the two key questions at the center of the ESO expensing controversy.

Unlike most written options, ESOs do not result in the receipt of a cash premium by the writer. The writer receives the labor of the employee in exchange for the ESO in the case where the ESO is taken to be a substitute for a cash wage payment. In the opposite extreme the ESO is a form of financing where the employee is extended the contingent choice to become a shareholder.

The settlement of an exercised option is reflected in the financial statements as an equity financing. This treatment is not at issue. The treatment of the ESO at all times prior to the exercise is the matter of controversy.

Written Options always create an obligation on the part of the writer, who must deliver a specified item if the option is exercised. Whether this obligation is a true liability or should be treated as some other entry on the “right hand side” of the Balance Sheet is a matter of controversy.

I.C.4. ESO Components: Intrinsic Value and Time Value

As early as 1986, the American Institute of Certified Public Accounts identified the difficulty of valuing stock options (AICPA Issues Paper 1986). They proposed a model for stock options for use in accounting where the Fair Value of the Option would be separted into two components: Intrinsic Value and Time Value. This accounting methodology presents the option in a different format than the format financial engineers use to value the options. The valuation for options, while typically associated with the Black-Scholes model, which led to the award of the Nobel Price in Economics, is by no means settled. In the controversy on ESO expensing, the variety of admissible option valuation models and the technique that maps resulting Fair Value into the components Time Value and Intrinsic Value raises the additional controversy of what measurement to record in any accounting policy, including ESO expensing.

A proposal to place stock options on the balance sheet and record their cost in Earnings as a reduction to Income met in the mid 1990s with unprecedented Congressional resistance in part because of its expected negative impact on the high tech industries. In 1995, the Financial Accounting Standard Board issued Financial Accounting Statement of Standards No. 123. This standard encouraged but did not require balance sheet recognition of ESO with a charge to Earnings. This standard also admitted the Black-Scholes model as an example of a suitable valuation model without limiting the entity's choice in using alternative valuation models.

However, the recent spate of accounting scandals has brought into focus the concerns of former SEC Chairman Arthur Levitt who stated in his 1998 speech at NYU, “The Numbers Game,” that the pervasiveness of accounting choice and manipulation was posing a significant challenge to perceptions of accounting quality in the United States. In the mid 1990s, stock options were not a part of Earnings, and some have considered that omission to have contributed to the failure in a U.S. accounting system that has been racked by widespread allegations of fraud ranging from ENRON and WORLDCOM to TYCO, and more.

The significant and pervasive level of Earnings manipulation that has been documented in numerous accounting scandals since the 1998 Levitt space introduces a new controversy: if Earnings are low quality, then the regulatory goals intended to be met by the use of Earnings to record the cost of ESOs may be confounded by further manipultation (including manipulation of the ESO accounting itself), have little purgative effect, and result in less, rather than more, transparency.

I.D. Review of the Current State of Accounting Rule-Making on ESOs.

I.D.1. The FASB Process Resulting in FAS123r (Released December 2004)

The mid 1990s accounting regulations required disclosure of the principal terms of stock options and only voluntary (not mandatory) “on balance sheet” treatment of stock options. (FAS 123, Stock Option Compensation.)

Shortly after the onset of the widespread accounting failures in 2001, Warren Buffet, the leader of Berkshire Hathaway, stated that he felt that the proper accounting for stock options would be as a charge to Earnings; that is stock options should be “expensed.” The International Accounting Standards Board (“IASB”), led by Sir David Tweedie has proposed accounting rules that would accomplish this.

However, the American accounting system has been slow to issue a standard requiring the expensing of stock options through Earnings. There are many reasons for this reluctance:
A. Valuation of stock options is not a settled science. The Black Scholes model, widely accepted for stock option valuation and the focus of a Nobel prize in economics, is acknowledged as too restrictive to impound all the contract terms of a compensation arrangement that includes a grant of stock options (see the Federal Accounting Standards Board (“FASB”) regulations).
B. Existing FASB regulations permit a variety of alternative methods of stock option valuation; the current FASB chair recently announced that the FASB was leaning towards binomial option pricing because it produces a “finer” result.
C. In fact, sophisticated financial engineering can exacerbate earnings manipulation through stock option contracts: evidence has surfaced in the business press that early adopters of stock option expensing are now generating unusually low expense charges by carefully choosing low volatility assumptions, high out-of-the-money stock prices (e.g. the recent IBM announcement) or altered contract terms, resulting in a decrease in the use of the stock options.
D. The FASB is in the midst of a negotiation with the IASB for the convergence of American accounting standards with those promulgated by the IASB; the idea of “expensing stock options” is viewed by some as a capitulation to a non-American standard setter operating in a labor market that has significant differences with that of the American workplace for high tech workers. Offering an alternative to direct expensing of stock options may help keep the American model competitive and permit the continued use of a very efficient compensation scheme.
E. Stock options' expensing is urged by investors who fear that stock options result in dilution; however the stock options proposals now before the FASB do not permit stock option accounting to articulate against other accounting variables that are stock being held in the form of treasury shares).
F. Stock options are a form of derivative that are carved out or excluded from the standard model for derivatives. (FAS 133).
G. Stock options expensing runs counter to the accounting concepts that govern transactions in a company's own common stock. For example, all parties accepted during the Congressional testimony on ENRON that fundamental accounting principles barred transactions in one's own stock from affecting Earnings.
H. Stock option expensing assumes incorrectly that stock options are akin to a salary expense when in fact they are also transactions between current and future shareholders.
I. The FASB should not propose inserting another variable, stock options, in Earnings, before
Earnings is defined and clarified, as is the goal of the Revenue Recognition project. Defining Core Earnings, as recommended by the economists, Burton Malkiel and William Baumol, is a higher priority and should be accomplished before stock options and other complex variables subject to manipulation by sophisticated financial engineering schemes is added to the “Earnings” variable that appears in the traditional capital markets multiple, P/E.
   I.D.2. The Introduction of Fair Value Accounting

After the 1995 release of FAS123 and the established loss of Earnings quality since 1998 many constituents of the SEC and FASB accounting rule-making process have reverted to a more classical “Balance Sheet orientation” to accounting. The FASB has, for example, placed derivatives other than ESOs on the Balance Sheet under FAS133, and clarified the rules for placing a given financial instrument in the Liability as opposed to the Equity portion of the Balance Sheet under FAS150.

Fair Value accounting is accepted by the FASB as the best measure to be used in recognizing financial instruments such as ESOs in the financial statements. The simple policy statement has fueled the ESO controversy: fair value as an accounting panacea is less powerful and sometimes unworkable if the underlying fair value methodology has not been accepted or cannot be readily audited; the transparency produced by fair value accounting does not exist if the reader of the financial statements do not have the requisite knowledge to understand the underlying financial engineering, and while fair value accounting for a financial instrument lends itself to reporting completeness with respect to the financial instrument, it cannot assure complete treatment of the underlying management behavior that causes the instrument to be used and or valued.

ESO accounting is a special subset of Fair Value accounting that breeds its own controversies since: there is a rich diversity in admissible valuation technology, readers of the resulting accounting as proposed by FAS123r must have an advanced knowledge skill set in about accounting and financial engineering, and ESOs are used as only one type of advanced compensation strategy.

By the end of 2004 the FASB had completed major components of its adoption of a Fair Value accounting model for financial instruments. That model, an evolution beyond traditional historric cost accounting has central concepts: the best measure for financial instruments is fair value, all financial instruments should be recognized on the Balance Sheet, and their cost and changes in their Fair Value should be reported in Earnings (sometimes as Income and other times as an Expense, depending on the form of the financial instrument and the market circumstances).

FAS115 and FAS130 applied forms of Fair Value accounting to most financial instruments except for ESOs, liabilities that are not hedged, and for the entity's own Equity instruments. A new controversy erupted within the ESO debate concerning the need to apply the concepts of Fair Value accounting to all financial instruments including ESOs.

In the case of ESOs that has broadened the opportunity for controversy. Until 2005, ESOs will be the only major class of derivatives that may be carried “off balance sheet”. Even if carried “on Balance Sheet” there remains wide flexibility in determining the measure, Fair Value, and which, if any of its accounting components are used in the Balance Sheet recognition process.

The FASB responded to this setting in 2003 by proposing a revision to FAS123. The draft accounting statement (Exposure Draft FAS123r, or “ED FAS123r”) encouraged ESO expensing, “on balance sheet” recognition of ESOs, Fair Value measurement, choice in the selection of a valuation methodology, use of the Fair Value accounting concepts and several exceptions to each of these new regulations.

In December 2004, the FASB issued the final amendments to FAS123, entitled FAS123r. For most entities, effective in 2005, ESOs must be Expensed in Earnings, recognized “on Balance Sheet” using some variation of Fair Value, with the entity retaining flexibility to choose the appropriate valuation methodology.

II. Inconsistencies IN FASB's Proposed Model

II.A. FAS123r Versus the Proposed Accounting Alternative

Understanding FAS123r as the user, reader, auditor or regulator requires advanced skills.

The proposed alternative, when implemented in its complete form, is based on simple concepts:
1. The expected receipt of the Strike Value under the ESO should be recognized;
2. Intrinsic Value is observable and easy to estimate—it should be used as the Fair Value;
3. ESOs are indexed to the entity's own equity, it should be carried in Equity where the dilution impact can be clearly reported.
4. The ESO should be marked-to market periodically, like all derivatives.
5. The “Cost” of ESOs should be charged to Comprehensive Income.

The proposed alternative in comparison to FAS123r is much simpler to understand, introduces more transparency, is consistent with the FASB Concept Statements, and is consistent with the other parts of the FASB's Fair Value accounting project.

FAS123r, the FASB's new accounting standard for ESO accounting is a step towards a full fair value accounting model for these financial instruments. However, since it is a transitional step with many exceptions and special applications it introduces as many inconsistencies as improvements. For example, the transitional model contains many inconsistencies with the FASB's Concepts Frameworks, other transitional accounting standards, and SEC guidance on fair value accounting. FAS123r, as published on December 2004 by the FASB has many technical features, is best implemented by readers with the requisite combination of accounting, financial engineering and capital markets knowledge, an contains over 200 pages of accounting rules.

Table 1 below summarizes some aspects of the complexity of FAS123r:

TABLE 1
FAS123r
Selected Principal Accounting Policies of FAS123r and FAS123r
admissible choices

| | Admissible Choices | |
|---|---|---|
| Accounting Policy (As required | | Condition that |
| for Public Entities) | Alternative | must be Met |
| Strike Value is never | NONE | N/A |
| Recognized | | |
| Expense ESO Fair Value to | Use Capital paid | Avoid certain |
| Earnings | in Surplus | exceptins |
| Record ESO Fair Value as a | Record as Equity | Comply with |
| Liability | | FAS150 |
| Fair Value = Intrinsic Value + | Intrinsic Value | Non Public Entity |
| Time Value | | |
| Fair Value is not remeasured | Remeasured | ESO classification |
| ESO Expense is not reversed if | Expense Reversal | ESO classification |
| Option not Exercise | | |

This analysis is limited to the principal choices permitted by the proposed accounting model.

II.B. The Inconsistencies in ESO Accounting Under Fas123r and its Precedents

Some of These Inconsistencies and Departures are Summarized as Follows:

1) Expensing and Carrying as a Liability a Cash Inflow

When options are exercised, say at a strike price of $30 when the stock is trading at $50, the entity receives a cash inflow of $30. The difference of $20 is an opportunity cost.

The action in a stock option is similar to the equity option within a convertible security. In that instance the convertible is exchanged for stock. Instead of a cash inflow there is a stock issuance to a third party, which are economically equivalent events (the cash was received by the entity when the convertible was issued). The accounting for stock options can lead most financial statement readers to wonder how a liability and expense can result in a cash inflow when the options are settled. It takes quite a bit of financial engineering to make this counterintuitive link.

Maybe the accounting for the opportunity costs related to exercised convertibles should be changed to report this through Earnings as well. (This would have sizable impacts at Berkshire Hathaway and Fannie Mae where Warren Buffett and Franklin Raines have been frequent supporters of stock options expensing.)

2) Expensing from a Transaction in One's Own Equity

Prior SEC guidance, including FAS133, precludes the use of Earnings to reflect accounting flows that arise from trades in the entity's own Equity. (Public information on the Enron accounting scandal documents an instance where the SEC denied the SEC issuer's Earnings Recognition policy because, among other things, the Earnings were being manufactured from a series of transactions linked to the SEC issuer's own stock.) ESO expensing contradicts this generally accepted view by using a financial engineering trick: the equity can be sold for cash and generates income to the holder equal to the $20 entity opportunity cost.

This is quite a “sharp pencil” approach to a difficult concept, and not entirely correct.

3) Hedging the Foreign Currency Risk in a Net Investment in Foreign Subsidiary

(For an example of this fairly rare policy see the financial statements of Baxter Travenol.) Under FAS133 most of the derivative value changes linked to this hedge may be housed in equity. Why can't a separate line item in Equity be used for stock options? See the author's note on Comprehensive Income for a development of this alternative. Maybe the accounting for Net Investment Hedging should flow through Earnings as well.

4) Stock Options are “Hedged” by Treasury Share Repurchases

If we amend stock options accounting by expensing, then we should revisit Treasury Share accounting. Currently Treasury Shares are held in Equity at historic cost.

Maybe Treasury Share accounting should be modified to fair value accounting and when repurchase programs exist, the Treasury Shares should be linked to the stock options using the hedge accounting rules in FAS133, which is everyone's favorite standard on derivatives.

5) The Cost of ESOs Must be Expensed in Earnings

EDFAS123r and FAS123r as published requires ESO expensing. FAS123r essentially reflects the position that if an item is a “cost” it must also be an “expense” for Earnings purposes.

There are at least two difficulties with this notion which have been documented in the continued controversy about ESOs: the notion of opportunity cost and the confusion when costs relate to asset acquisition rather than an Earnings event.

In the case of ESOs, the cost in question is the Fair Value of the ESO. That cost is the “bargain element” that an employee realizes upon exercising the option. It is nothing more than an opportunity cost to the entity. Former Chairman of the President's Council of Economic Advisers and Harvard Professor Mankiw notes in his text ECONOMICS that opportunity costs do not represent Earnings. By extension, if ESOs are measured at their Fair Value, or a component thereof, Earnings recognition is conceptually precluded to the extent those values are opportunity costs.

Not all costs represent bona fide current Earnings events. This is true in the case of an acquisition of an intangible asset whose cost is kept out of Earnings until that cost has declined permanently. It is also the case if the costs are unrealized and potentially reversible.

6) The Cost of ESOs is Best Reflected in Earnings Rather than Elsewhere in Financial Statements

FAS123r, published in 2004, is at variance with the FASB Concept Statement (insert right one), which established the precedent that “stock warrants should be carried in the Equity part of the financial statements’). Stock warrants are similar to stock options in that both financial instruments are option contracts on the entity's own Equity and generally, both represent written options from the entity's perspective. The FASB Concept Statement can be extended as a sufficient precedent to the accounting treatment for both Earnings Recognition and Balance Sheet Recognition of ESOs.

FAS130 and the FASB Concept Statement (state which one) describe a broader measure of Income than Earnings; this is labeled Comprehensive Income. Items that represent economic, tax, transaction, and or cash flows, and often are unrealized or merit deferral, are often excluded from Earnings, and are treated under FAS130 as “other Comprehensive Income” (“OCI”). FAS133 established a precedent to carry both realizwed and unrealized gains on derivatives, other than ESOs, in Accumulated OCI rather than Earnings. FAS115 applies this logic to certain other Financial Instruments, except ESOs, held as assets. These precedents and the character of ESOs supplies the necessary conditions to suggest that the “expense” associated with ESOs is better reflected in OCI than Earnings; in either choice, the “expense” would remain in Comprehensive Income in a manner that is conceptually consistent with the FASB framework as embodied in the FASB. Concepts Statements.

Do not Ignore FAS133 Fair Value Accounting

If we expense stock options at grant date using fair value, then we might as well refresh the value by marking to market every reporting date, as required for most other derivatives under FAS133. This would make FAS123r more consistent with FAS115 and FAS133 as possible (the two other standards dominated by fair value accounting).

Technique 1

The accounting literature prior to stock options accounting under FAS123r stated that any option value could be split as follows:
Fair Value=Time Value+Intrinsic Value (Subject to a Minimum Value of 0)

The Fair Value could be a market price or, since stock options are not traded, a mark-to-model value. Intrinsic Value is some positive number if the option is in the money and zero if it is out of the money; this is the notion Warren Buffett talks about and is familiar to most. The option can never have a value less than zero. And time value is an accounting artifact: the number CPAs use to reconcile to Intrinsic Value, which they can see, to Fair Value, which they are given and must verify.

In stock options, Fair Value=Time Value because Intrinsic Value is zero at grant date.

Technique 2

In FAS133, the SEC concepts surrounding internal derivatives prevent the entity from reporting a derivative position which is not with an outsider: the acid test is that if the derivative cash flows do not go out of the entity or come back into the entity the derivative should not be reported in the entity's external audited consolidated reports.

If we were to apply this notion to stock options, then the Time Value above would never result in an external cash flow and should be ignored for reporting purposes. FAS123r's expensing of stock options amounts to expensing of Time Value which is an opportunity cost.

The current debate around stock option accounting has a sub-plot on the difficulty of valuing stock options. For the CPA, the challenge is to value yet another complex derivative and to establish an audit framework for it. Stock options are more complicated than other derivatives due to structure and markets. In terms of structure, stock options have idiosyncratic terms such as “grant date” and “vesting period” which should be incorporated into the valuation and audit. Market prices do not exist for employee stock options and so valuations follow what accountants call “mark-to-model” methodology.

While there are numerous ways to value options (with the most widely accepted model being Black-Scholes) these valuation models do not lend themselves easily to the accountant's model for an option.

Accordingly, an effective accounting model for stock options which offers, e.g., an effective alternative to expensing through Earnings, is highly desirable.

### SUMMARY OF THE INVENTION

The present invention offers a feasible technical solution to handling financial accounting for stock options which advantageously has the following positive attributes: It is
politically neutral;
consistent with the FASB Concept Statements;
understandable using simple accounting and financial engineering knowledge;
relatively neutral to the controversy between historic and fair value accounting models because it is
   traditional in its focus on accounts related to actual cash flows;
   to the extent the use of fair value precepts is preferred, a more complete reflection of fair value accounting with respect to:
      Limiting values to the best verifiable estimate;
      Remeasuring values for reporting purposes;
      Recognizing certain values that are directly linked to cash flows.
It represents a progression and solution to the current attack on the mixed attributes model.

In one aspect of the present invention, a system for performing a stock option valuation utilizing a processing element is provided which comprises creating an account on a balance sheet to store values associated with said stock option valuation, and performing one or more of the following steps:
posting future expected strike price on the balance sheet pursuant to the terms of the employee's contract granting the stock option;
estimating the fair value of the stock option on the balance sheet by discounting the time value of said stock option;
expensing the fair value of the stock option on the balance sheet under Other Comprehensive Income (OCI); and
periodically marking-to-market the carrying fair value of the stock option on the balance sheet.

In yet another aspect of the present invention, a program storage device readable by a machine, tangibly embodying a program of instructions executable by the machine to perform method steps for performing stock option valuation is provided, the method comprising the steps of creating an account on a balance sheet to store values associated with said stock option valuation; and performing at least one of the following steps:
posting future expected strike price on the balance sheet pursuant to the terms of the employee's contract granting the stock option;
estimating the fair value of the stock option on the balance sheet by discounting the time value of said stock option;
expensing the fair value of the stock option on the balance sheet under Other Comprehensive Income (OCI); and
periodically marking-to-market the carrying fair value of the stock option on the balance sheet.

These and other aspects, features, and advantages of the present invention will be described or become apparent from the following detailed description of the preferred embodiments, which is to be read in connection with the accompanying drawings.

### BRIEF DESCRIPTION OF THE DRAWINGS

FIG. 1 is a functional flow diagram illustrating an exemplary operative process according to an aspect of the present invention;

FIG. 2 is a flowchart of an exemplary process detailing step 109 of FIG. 1 according to an aspect of the present invention;

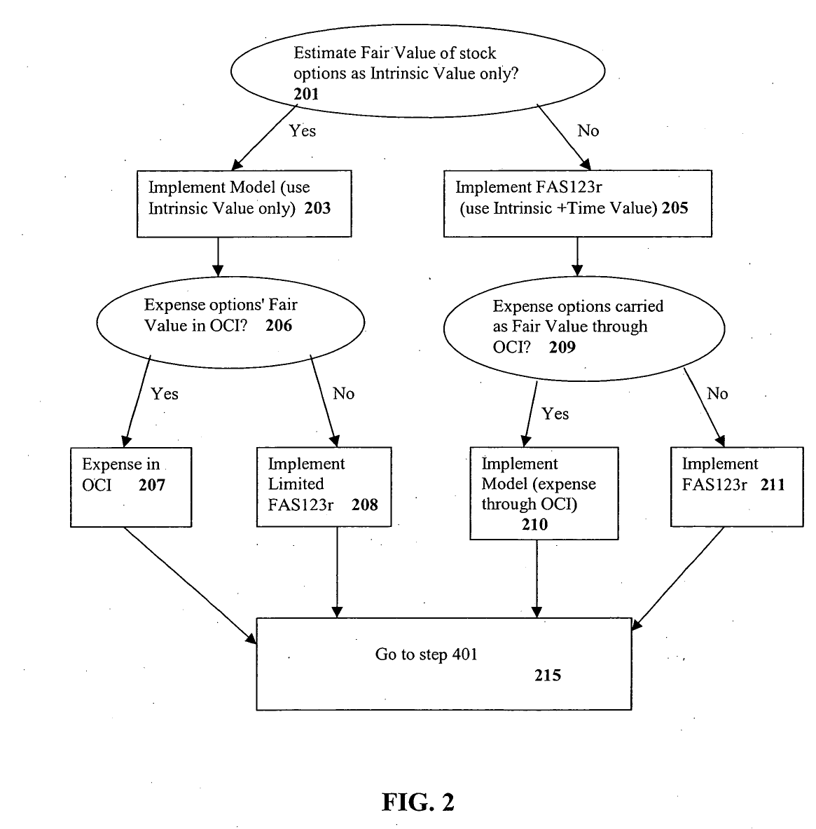

FIG. 3 is a flowchart of an exemplary process detailing step 111 of FIG. 1 according to an aspect of the present invention;

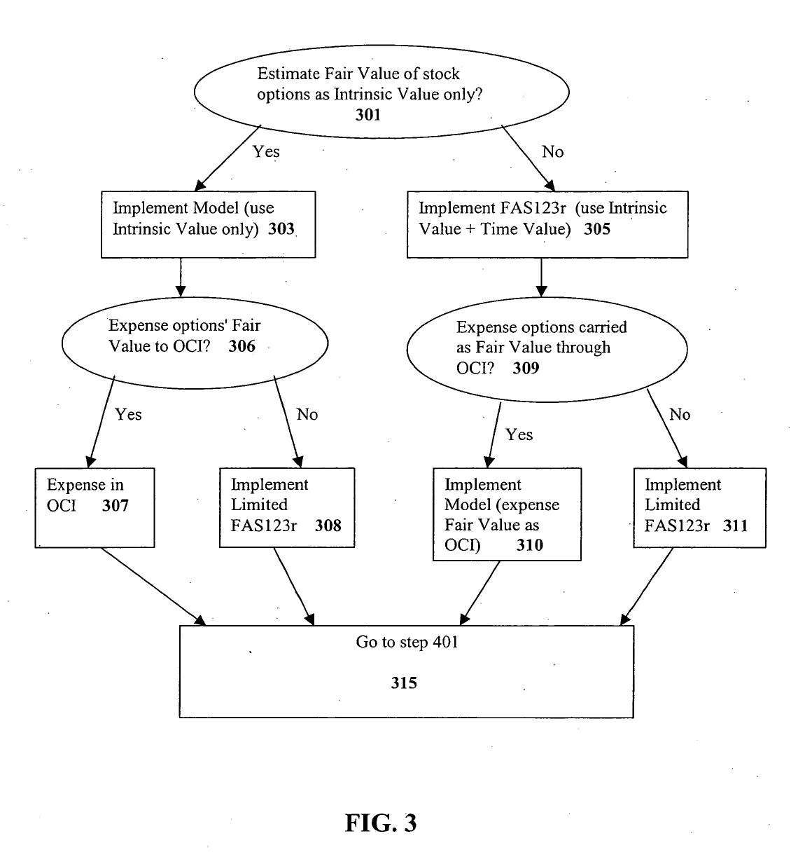

FIG. 4 is a flowchart of an exemplary process detailing step 315 of FIG. 3 according to an aspect of the present invention;

FIG. 5 is a flowchart of an exemplary process detailing step 415 of FIG. 4; and

FIG. 6 is a flowchart summarizing the process shown in FIGS. 1-5.

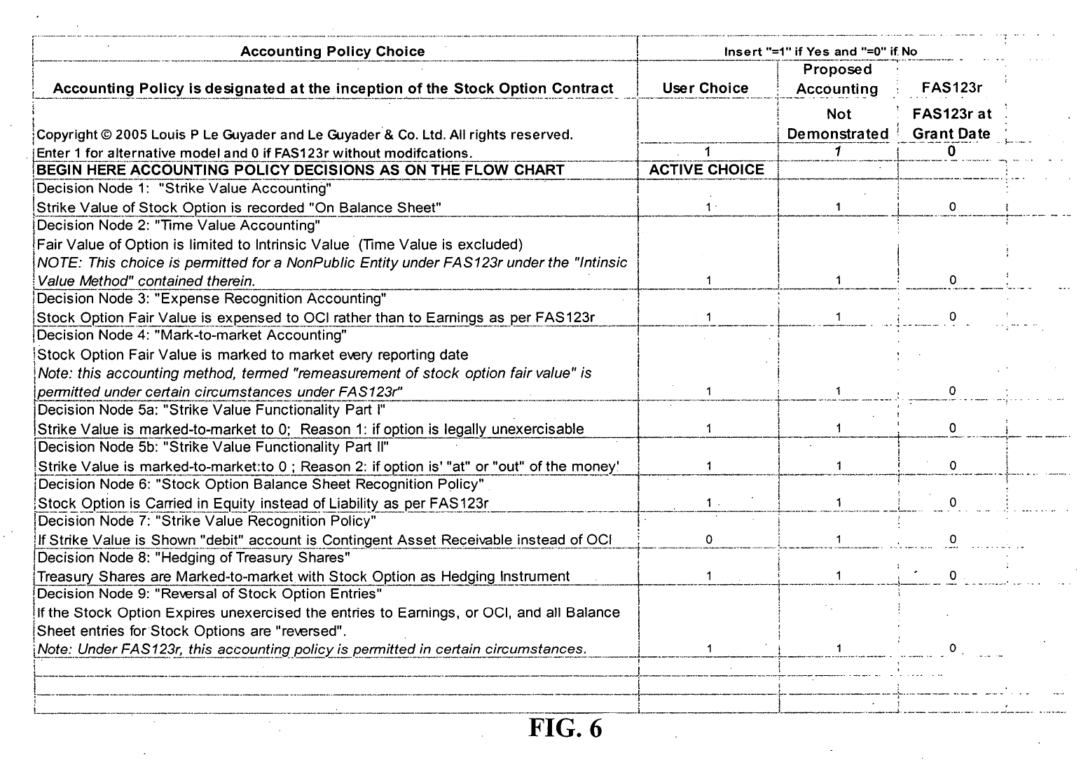

### DETAILED DESCRIPTION OF PREFERRED EMBODIMENTS

It is to be understood that the exemplary system modules and method steps described herein may be implemented in various forms of hardware, software, firmware, special purpose processors, or a combination thereof. Preferably, the present invention is implemented in software as an application program tangibly embodied on one or more program storage devices. The application program may be executed by any machine, device or platform comprising suitable architecture. It is to be further understood that, because some of the constituent system modules and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate or practice these and similar implementations or configurations of the present invention.

The issues addressed by the present invention are as follows: (1) how should stock options be valued for accounting purposes; (2) should the stock options accounting appear in Earnings; (3) can the proposed methodology create accounting variables that can be audited; and (4) is the proposal consistent with existing rules for Comprehensive Income and other transactions in common stock?

In one embodiment, the present invention comprises, e.g., the following steps:
1. Add the Strike Value of the stock option to the values recognized on the Balance Sheet
   A. Note: Strike Value (for a stock option contract)=Strike Price X Number of Shares, where:
   B. Strike Value is the constant amount in 1.A. above throughout the term of the ESO or, at the preference of the user, the alternative constant amount of 0 (“zero”) in the event that either or both of the following conditions apply: the ESO is not exercisable (the Vesting Date has not been attained) and/or, exercise of the ESO is remote as the it is other than “in the money” (that is the Intrinsic Value is zero), where “remote” can be expanded by the user for other manifest reasons.
2. Broaden the Income recognition of the ESO in both its levels and changes beyond Earnings to the complete category Comprehensive Income (as defined in the FASB Concepts Statements) as follows:
   A. Rather than Earnings, elect to account for all Income activity in employee stock options through the Other Comprehensive Income component of Comprehensive Income, net of taxes, as permitted for other non Earnings events under FAS 130; where
      1. the user must make three independent decisions as to whether that Income activity, whether recorded in Earnings or OCI should be measured using the ESO values:
         a. Strike Value;
         b. Intrinsic Value: and/or
         c. Time Value.
      2. the user may substitute for Other Comprehensive Income in case 2.A.1.a. above, an Asset account (labeled, for example, Contingent Strike Value Receivable).
   B. Treat employee stock options as a de facto hedge of Treasury Shares and thus present Treasury shares and stock options as components of Equity instead of as a Liability (e.g., in a similar manner as when one presents a debt on the liability side of the balance sheet and an interest rate swap hedging that debt as component of the Balance Sheet); wherein, the user may make two independent accounting designations:
      a. ESOs are either Liability or Equity Accounts;
      b. ESOs are designated as a hedge of Treasury Shares
   C. When the amount of Treasury Shares and Stocks subject to stock options granted is equivalent, reduce the accounting variable for the stock options to the Intrinsic Value of the Stock Option (this is the equivalent of 100% economic effectiveness in the foreign currency hedge of a net investment in foreign subsidiary, which is permitted under the DIG implementation guidance for FAS 133 and FAS 52);
   D. Note: (Intrinsic Value=stock price less exercise price, subject to a minimum of zero);
   E. Eliminate the scoping out of stock options from FAS 133; require the marking-to-market of both stock options, and the item that constitutes, in effect, the hedged item (e.g., the Treasury shares) on the Balance Sheet in the Equity portion of the Balance Sheet, with the mark going through Other Comprehensive Income.
   F. In the event that ESOs expire unexercised, reverse the cumulative ESO entries from all accounts.

The present invention's proposal of, e.g., an effective alternative to “stock option expensing through Earnings” involves the use of the accounting model's new variable,

Comprehensive Income, a provision for ESOs which the FASB has heretofore declined to consider.

Comprehensive Income has not been the subject of a final accounting standard in the IASB. The current analysis of that account by the IASB identifies that account as a location to record changes in value including unrealized gains and losses due to the effect of peripheral events. The changes in value of a financial instrument such as an ESO, dependent as they are on the fluctuation of market factors including the price of the entity's stock, interest rates and expected volatility, This proposed alternative includes a valuation framework and variable, Intrinsic Value, and proposes the exclusion of the variable Time Value which appears sporadically in accounting literature, but frequently in the literature of the capital markets. Its use is consistent with the FASB definition of Fair Value as contained in FAS 133.

In one embodiment, a proposed model according to the present invention involves the following:

1. The Strike Value of the ESOs are recorded on the Balance Sheet. The Strike Value of the Stock Options should be recorded on the Balance Sheet since this is the amount needed to forecast the future cash inflow if the options are exercised. The Strike Value is a financing and reporting value and so like Cumulative Translation Adjustments can be treated as an OCI offset.
2. The Fair Value of the ESOs. are recoreded on the Balance Sheet as Intrinsic Value only, or alternatively, the sum of Intrinsic Value and Time Value,
3. Stock Options are recorded on the Balance Sheet with an offset to Other Comprehensive Income, rather than Earnings, with the provision that the offset to Strike Value may be a Contingent Asset account rather than OCI. (The Intrinsic Value of the stock option while never received by the company is not a cash payment made to stock option exercisers. It is an opportunity cost that is not incurred if the options expire worthless and/or unexercised. Time value never results in a cash outflow. Earnings are not used to record the time value of the stock options as this cost component will (1) not be borne if the options expire worthless, and (2) never result in a cash outflow to a third party. The use of OCI rather than Earnings for these two components avoids the economic flaw of recording opportunity and noncash costs in Earnings.)
4. The Carrying Amount of the stock options is remeasured, that is updated, or marked to market, at every reporting period.
5. As a result, the Comprehensive Value of the Stock Options for Balance Sheet Purposes is composed of the sum of the Strike Value, the Time Value and the Intrinsic Value of the stock options (and in cases depending on the combination of accounting choices the values for Strike Value and Time Value are independently fixed to the constant 0 (“zero”).
6. In both FAS123, FAS123r and the proposed model we must observe the following entry when the stock options are tendered with the Strike Value for the Common

Shares:

| | |
|---|---|
| Debit Cash | XXXX (strike value) |
| Credit Common Stock | XXXX (strike value) |

This entry clearly demonstrates that the stock options are principally a financing activity.
7. ESO accounts that remain at the maturity date of the ESO contract are reversed.
   This eliminates the error of recording a permanent non-cash cost in Retained Earnings.

### I. Accounting for the Options' Strike Price

The FASB's unrelenting march towards stock options expensing is near completion. That march forces some careful thinkers to review the FASB's own Concepts Statements. A careful thinker will find that the “sharp pencils” were either not sharpened, or left unused, on one critical matter related to fair value accounting: the options' strike price.

The Stock Option's Strike Price

Holders of stock options will only exercise their options if, on the exercise date, the price of the entity's shares are above an exercise or strike price contained in the option contract—the option is “in the money” from the holder's point of view.

If the share price is $50 and the strike price is $30, the option will be exercised with the payment of $30 in return for a share which is presumably worth $50; the option holder's wealth has increased by $20. If the share price is $25 and so below the $30 strike price, the option is out of the money and will not be exercised; the option holder's financial wealth will not increase and he may, or may not, feel he has suffered the opportunity cost of working for the entity in return for a worthless piece of option paper.

Financial engineers like to believe that in all this, it is obvious that when the option is exercised, the entity receives the strike price of $30, Since the entity issues shares a simple accounting for this would be:

| | |
|---|---|
| Debit Cash | $ 30 |
| Credit Stock | $ 30 |

There is no accounting for the “no exercise” case as cash does not flow in.
Stock Option Accounting as Part of the Fair Value Accounting Model

The FASB has been changing the basic accrual accounting model to include fair values. The FASB considers fair value to be the best measure for financial instruments, including stock options. One of the precepts of fair value accounting is that “all is revealed” and so the reader of the accounts is left with a reduced surprise as to the ultimate impact on the entity's cash account.

But the accounting for other derivatives seems, on the surface different: contrast stock option accounting to interest rate swap accounting. A stock option has either a value, because it should be exercised, or no value. All other non-option derivatives do not have this “limited value” condition. In a swap, for example, the value can rise and fall with interest rates: the value can be negative (you will pay cash) or positive (you will receive cash).

In fair value accounting, the actual value of the swap on the balance sheet under FAS133, whether positive or negative, directly and nearly perfectly forecasts the cash that would be received or paid if the swap were liquidated on the reporting date. This is consistent with the goals of fair value accounting: full revelation and transparent reporting of cash events. Not so for stock option accounting.

The value of the stock option on the reports is only an indirect, if nearly perfect, signal to forecast a possible cash inflow. To sort out the exercise price the reader needs to indulge in some financial engineering: disaggregate the stock option contract and assess the probability of exercise. This is an example of how fair value accounting is opaque and impenetrable.

Summary of Proposed Technique to ‘Fix’ the Stock Option Accounting Rules:

There is an addition to the proposed stock option rules with respect to exercise price. On the balance sheet the entity should record the following entries:

| | |
|---|---|
| Debit Prospective Stock Option Receipt (Asset) | XXXX |
| Credit Stock Option Exercise Price (Equity) | XXXX |

What do we use for the “XXXX”? Preferably “0” when the option is “out of the money” and the strike price of $30 when it is “in the money”. If the option is not exercised (presumably only if it is out of the money) then the accounts can be terminated without numerical effect. If the option is exercised:

| | |
|---|---|
| Debit Cash | $30 |
| Credit Prospective Stock Option Receipt | $30 |
| Debit Stock Option Exercise Price | $30 |
| Credit Stock | $30 |

This amendment would be acceptable even without the use of fair value accounting: it would place the stock option on the balance sheet in a careful link to the cash account.

The Equity account is correctly used here for a simple reason: the issue of stock for an exercise payment is a capital raising event, not an earnings event, at a discount.

This is the simple part of stock option accounting that the FASB has chosen to leave to the side. It is the accounting for the discount that is controversial and leaves much to be desired.

The current debate around the accounting for stock options at the FASB is centered on the question of how to value these derivatives. The present invention demonstrates that the complex legal terms of incentive stock options can be mapped into a fully descriptive quantitative financial contract; this contribution, the mapping of legal incorporated the milestone of modeling normal distributions. (Black Scholes 197x). The present invention then demonstrates that the complex legal contract can be decomposed into standard elements by combining technology from accounting and financial economics (Smithson 199x). Finally the model is used to derive the result that the intrinsic value of the incentive stock option is the necessary and sufficient value that should be incorporated into the audited financial reports of entities that use these contracts; this represents a significant advance in practicability at a time when the FASB has formed a Valuation Advisory Group as it prepares to issue a new standard on incentive stock options. (FASB 2003).

The present invention's reference to “FAS123r” refers to the current FASB standard, a copy of which may be found at http://www.fasb.org/pdf/fas123r.pdf and is herein incorporated by reference. A brief summary of some key provisions of FAS123r is as follows:

Summary of FAS123r:

“FAS123r” is the accounting statement issued by the FASB in December, 2004, that governs the accounting for employee stock options in financial statements with effect from late 2005. The central provisions of FAS123r as stated by the FASB are:
   (1) Statement of Financial Accounting Standards No. 123 (revised 2004), Share-based Payment, Financial Accounting Series No. 263-C, ISSN 0885-905, Financial Accounting Standards Board, Norwalk, Conn., USA, December 2004 (“FAS123r”)
“This Statement requires . . . [the measurement of] the cost of [employee stock options] . . . based on the grant-date fair value . . . (with limited exceptions). That cost will be recognized [in the financial statements as detailed in the body of the standard].” (2) and
   (2) Paragraph 1 on page “ii” of FAS23r in “SUMMARY: Key Provisions of this Statement”.
“A pubic entity will initially measure the cost [of employee stock options as] liability instruments based on its current fair value. [This fair value will be] remeasured . . . at each reporting date through the settlement date. Changes in fair value . . . . will be recognized as compensation cost . . . “(3) and
   (3) Paragraph 1 on page “iii” of FAS123r in “SUMMARY: Key Provisions of this Statement”.
“The grant-date fair value of employee [stock] options . . . . will be estimated using option-pricing models [that are appropriate in the circumstances including modifications for] the unique characteristics of those instruments . . . ” (4)
   (4) Paragraph 2 on page “iii” of FAS123r in “SUMMARY: Key Provisions of this Statement”.
Prior to the 2005 effective date of FAS123r recognition of stock options in the financial statements was not required. FAS123r is presented as a revision of the accounting standard FAS123 issued in the mid-1990s.

### II. Exemplary Process for the Alternative Model

An Alternative Model according to the present invention provides that an account be recognized on the Balance Sheet for the expected future and contingent receipt of Cash by the ESO writer when the ESO is exercised by the ESO holder (the “Strike Value (or Exercise Value) Account”).

The ESO alternative model proposes two forms for the entry (where for example the Strike Price is fixed at $10):

| | |
|---|---|
| Debit Other Comprehensive Income | 10 |
| Credit Stock Option Account | 10 |
| Or if preferred | |
| Debit Contingent Strike Price Receivable | 10 |
| Credit Stock Option Account | 10 |

It is easy to observe that the value of an ESO is dependent on the Strike Price (or Exercise Price). The Strike Price is a contract term that is a “value relevant” or a “critical term” in the sense the words are used in accounting art.

Not withstanding this the separate display of the Strike Value according to the present invention that is economically significant and material in the accounting art.
1. When Strike Price is a component of an ESO value, it represents in the accounting art a “best estimate” or input into the value. The proposed methodology raises the hierarchical status of strike Value from that of a parameter to that of a full accounting variable. It gains representational equality to the fair value of the ESO itself. (In traditional accounting an estimate or parameter might be the currency in which a receivable is denominated, the receivable is a itself is the accounting variable that is dependent on the parameter. The receivable appears in the financial statements, the currency itself is only one factor that contributes to that outcome.)
2. The reporting of the Strike Price in this manner increases transparency in a way that an implied report as a parameter of ESO fair value cannot provide:
   a. To discern the Strike Price in an ESO fair value one engage in “reverse engineering” of the ESO fair value. That is almost impossible generally and well outside the competence of most accounting readers.
   b. The ESO fair value is a cost and economic outflow to the ESO writer while the Strike Price is not a cost and unlike the ESO results in both an economic and a financing inflow. The distinct attributes require separate treatment.
   c. The offset to the Stock Option entry also adds value and either alternative above sends a “value relevant” signal:
      i. the use of an Asset account that is labeled “Contingent” signals the uncertainty of the cash receipt and common stock financing which is dependent on many factors surrounding the ESO;
      ii. the use of the OCI account and specifically the debit highlights that the ESO writer adds to dilution by writing the ESO and that the ESO is a method of deferring the cash receipt to a future prospective exercise date
   The Strike Price variable has characteristics of both an asset and a financing opportunity cost and so either choice sends a “value relevant” signal.

3. The account prepares the financial statement reader for both the cash inflow that will accompany the exercise of the ESO and the equity financing that results at the price per share that is net of the ESO intrinsic value or “bargain element” retained by the ESO holder. Upon exercise, regardless of the market price for the shares, we will see, for example

| | |
|---|---|
| Debit Cash | $ 10 |
| Credit Contingent Asset | $ 10 |
| And | |
| Debit Stock Option Account | $ 10 |
| Credit Common Stock | $ 10 |

The Alternative Model refers to a model according to an aspect of the present invention, which advantageously provides a user with choices (user-selectable inputs) in which to specify/indicate various desired attributes during the accounting process for stock options. That is, in one embodiment, the Alternative model according to the present invention provides, e.g., at least nine different decision inputs in which the user may customize accounting decisions, thus providing greater flexibility in the overall accounting process for stock options, as well as a system which is less prone to error.

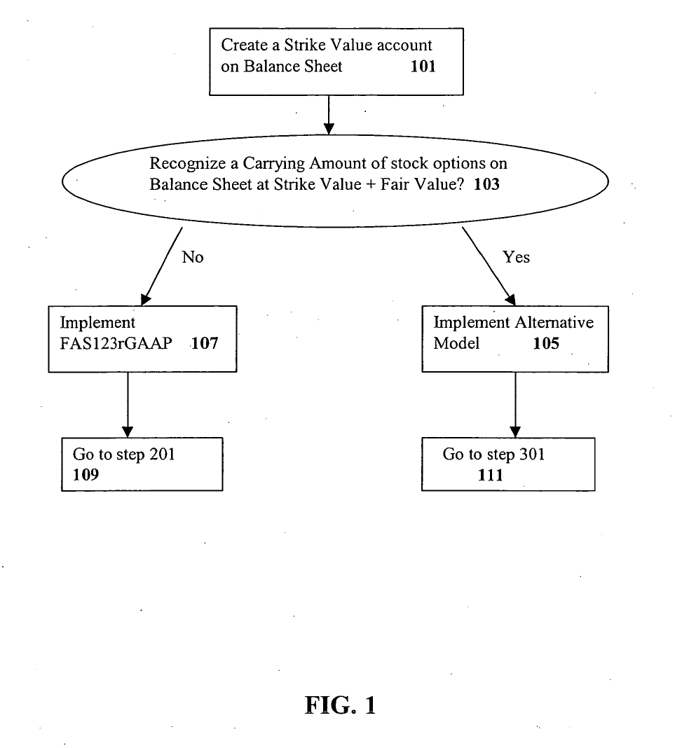

It is to be noted that the chronology of the flow process depicted in FIGS. 1—is for exemplary purposes only, and that the Alternative Model according to the present invention may include, e.g., decision nodes (blocks) in any order or progression. That is, e.g., the overall consideration of Decision Nodes 1-9 maybe represented in any of 9! (factorial) number of progressions.

Referring now to the Figures, in step 101 a Strike Value Account is preferably created on a Balance Sheet. The Strike Value account is designed to receive any future expected strike price as specified by the stock option contract. Decision node 103 (“Strike Value Accounting” decision node) is provided for permitting a user to indicate whether to recognize a carrying amount of stock options on the Balance Sheet at Strike Price+Fair Value; in other words, whether to record the Strike Value of a Stock Option on the Balance Sheet. If yes, the Alternative Model is implemented (step 105) and proceeds to step 301; if no, the FAS123r model is implemented (step 107) and proceeds to step 201.

In step 201 a decision node (“Time Value Accounting” decision node) is provided for permitting the user to specify whether to estimate the Fair Value of the stock options as Intrinsic Value only; i.e., whether the Fair Value of the Stock Options is to be limited to Intrinsic Value, wherein Time Value is to be excluded. Results from this decision node are as follows:
a) If yes, the Alternative Model is implemented (step 203) and proceeds to step 206, in which a decision node (“Expense Recognition Accounting” decision node) is provided for permitting the user to specify whether to expense the options'Fair Value in Other Comprehensive Income (OCI) rather than to Earnings, as per FAS123r. If yes (step 207), the options are expensed as OCI and proceeds to step 401. If no, the FAS123r model is implemented (step 208) and proceeds to step 401.
b) If no, the FAS123r model is implemented (step 205) and proceeds to step 209, in which a decision node (“Expense Recognition Accounting” decision node) is provided for permitting the user to specify whether to expense the options'Fair Value in Other Comprehensive Income (OCI). If yes (step 210), the options are expensed as OCI and proceeds to step 401. If no, the FAS123r model is implemented (step 211) and proceeds to step 401.

In step 301, a decision node (“Time Value” decision node) is provided for permitting the user to specify whether to estimate the Fair Value of the stock options as Intrinsic Value only. Results from this decision node are as follows:
a) If yes, the Alternative Model is implemented (step 303) and proceeds to step 306, in which the Expense Recognition Accounting decision node is provided for permitting the user to specify whether to expense the options'Fair Value in Other Comprehensive Income (OCI). If yes (step 307), the options are expensed as OCI and proceeds to step 401. If no, the FAS123r model is implemented (step 308) and proceeds to step 401.
b) If no, the FAS123r model is implemented in which Fair Value=Intrinsic Value+Time Value (step 305) and proceeds to step 309, in which a decision node is provided for permitting the user to specify whether to expense the options'Fair Value in Other Comprehensive Income (OCI). If yes (step 310), the options are expensed as OCI and proceeds to step 401. If no, the FAS123r model is implemented (step 311) and proceeds to step 401.

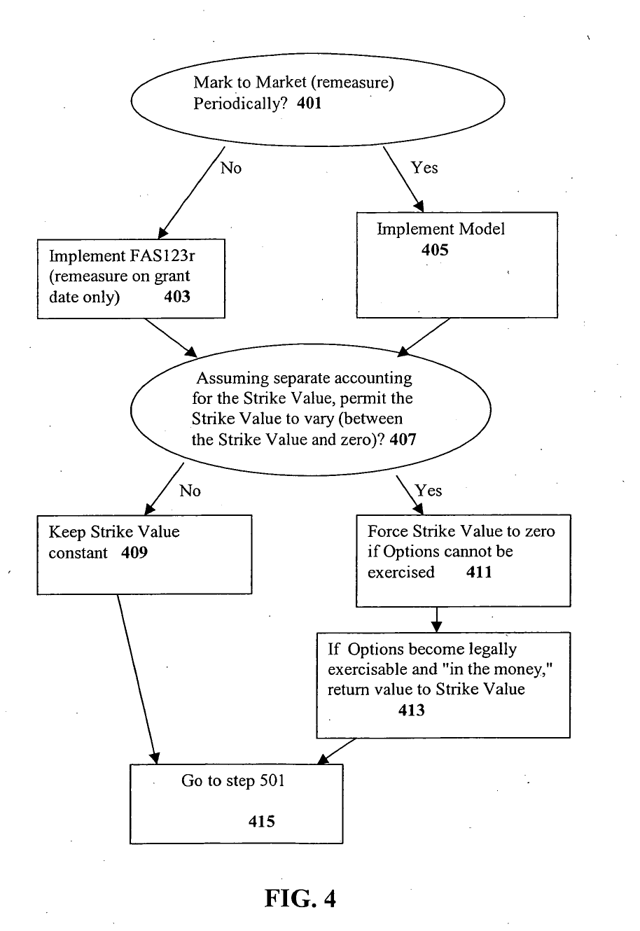

In FIG. 4, a “Mark-to-market Accounting” decision node 401 is provided in which a user may select whether to Mark-to Market (‘Remeasure’) the stock options periodically; that is, whether the stock option Fair Value is to be marked to market (remeasured) every reporting date. If yes, the Alternative Model is implemented (step 405) and proceeds to step 407. If no, the FAS123r model is implemented (i.e., the stock options are remeasured on grant date only) in step 403 and proceeds to step 407.

In step 407, a “Strike Value Functionality” decision node is provided wherein assuming separate accounting is implemented for the Strike Value (i.e., the answer for step 103 is ‘yes’), a user may indicate if the Strike Value Account is to be permitted to vary (i.e., vary between the Strike Value and zero). If yes, the process proceeds to step 411, wherein the Strike Value is forced to zero if the Stock Options cannot be exercised (i.e., the Stock Options cannot be exercised due to legal reasons—it has not yet vested; or it will not be exercised because it is not ‘in the money’). Note that if the option is both legally exercisable (vested) and economically exercisable (in the money), its value returns from a value of zero to the Strike Value (step 413). In step 415, the process proceeds to step 501.

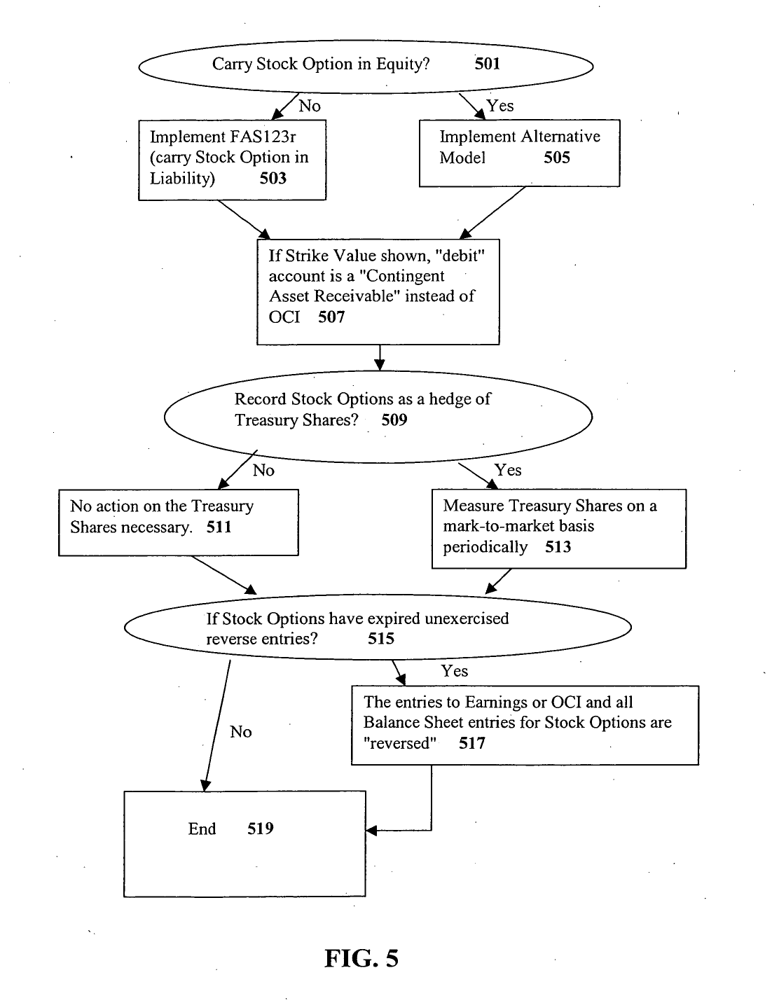

In FIG. 5, a “Stock Option Balance Sheet Recognition” decision node 501 is provided to permit a user to indicate whether to carry the Stock Option in Equity (step 505) instead of Liability (as per FAS123r) in step 503. A “Strike Value Recognition policy” node 507 is provided wherein if the Strike Value is shown (i.e., if the answer to step 103 is ‘yes’), a “debit” account is a “Contingent Asset Receivable” instead of Other Comprehensive Income (OCI).

In step 509, a “Hedging of Treasury Shares” decision node is provided in which a user may elect to record Stock Options as a hedge of Treasury Shares (when stock options are present, if a company has treasury shares, than it can treat the existence of the stock options and treasury shares as a hedging relationship and both are marked to market). If yes, the Treasury Shares are measured on a mark-to-market basis periodically (step 513)—this provides a Fair Value offset to the Stock options which otherwise would not exist. If no, no action on the Treasury Shares is necessary (step 511).

In step 515, a “Reversal of Stock Option Entries” (i.e., “Expense Reversal”) decision node is provided wherein if the stock options have expired unexercised, the entries to Earnings or OCI and all Balance Sheet entries for Stock Options are “reversed” (step 517). Following steps 515 and 517, the process of accounting according to one embodiment of the present invention for a given set of Stock Options is done (step 519).

Further, in an additional embodiment, the present invention advantageously provides an error protection mechanism. It is to be noted that for example, if during use of the software according to the present invention the user selects the FAS123r standard, the software will preferably automatically disable or force to a value of “Zero” any accounts that would be utilized had any of the attributes of the alternative model according to the present invention been selected. In addition, if any of the attributes are selected that would trigger use of the alternative model of the present invention, the FAS123r accounts are preferably disabled or forced to a value of “Zero.”

The proposed accounting results in at least three cases in accounts being created in the reporting entity's financial statements with the measure being zero. For ESO accounting the position is taken that unlike other accounting prevalent in GAAP the account measured at zero should both exist and be displayed in the financial statements.

Two examples of this instance are:
1. if intrinsic value is zero for any reason the carrying amount of the stock option should be displayed as zero even if the entity chooses to report the fair value of the option excluding time value; this insures that the existence of a short option position is reported.
2. if the strike value is accounted for but the proper measure of the strike value is zero then the strike value account and the measure of zero should both exist and be displayed.

This ensures that some report of the option position is made and ensures that the economic signal sent to the market is the option exercise, if it occurs, will be for some positive cash flow and zero otherwise.

The economic argument that supports this approach is that “zero” is a value relevant accounting measure. It does not only mean that the account or activity does not exist. It signals the existence of a contract or a behavior and it attunes the reader to the possibility of a non-zero value some time in the future. This is consistent with the mathematical innovation from centuries ago that first provided for a “zero” as a placeholder in a system of numbers.

### III. Schematic Illustrating the Alternative Model

The following schematic (Part I and Part II) represents the pro form a debits and credits for this alternative method of accounting for stock options.

The central observations are:
1. Stock options only result in cash inflows and these inflows, net, are best represented as increases to the Common Stock account of the company;
2. Stock options have a market value but the cash inflows relate to the exercise of the options and the payment of the strike price;
3. The “expense” related to compensation never results in a cash outflow; the dilution related to exercise of the options always relates to a cash inflow.
   As provided in FAS 130 and FAS 133, cash flow hedge accounting permits market values of certain derivatives to reside in Other Comprehensive Income rather than Earnings. If the cumulative changes in fair value of the derivative is zero, Other Comprehensive Income will show volatility but there will be a cumulative impact of ZERO and the entries to Earnings may, and should, be ZERO and Cash must be ZERO.

The schematic consists of two parts:
PART I—Accounting for the portion of the stock option constituting market value;
PART II—Accounting for the portion of the stock option that results in a cash inflow and can be viewed as a de facto hedge of a position in Treasury shares.
   Part I

At grant date create a separate account for the Fair value of the Stock Option. That Fair value is never a Cash in-flow to the Company. ZERO is a placeholder of economic value and utility for internal control purposes.

The fair value below may either be the market value, the value from a model, the intrinsic value of the stock option or any other value admitted by accounting regulations. The argument put forward in the documents related to this schematic is that the best value is the Intrinsic Value, the difference between the Market Price of the underlying shares and the Strike Price embedded in the stock option contract.

At Grant Date

Debit Other Comprehensive Income 0
   Credit Stock Options−Fair Value 0
      From Grant Date to Vesting Date
Assuming Intrinsic Value is used, no entries.
Assuming some other Fair value is used,
Debit Other Comprehensive Income [Amount=Fair value Change, if positive]
   Credit Stock option—Fair Value [Amount=Fair Value Change, if positive] Or,
Debit Stock Option—Fair Value [Amount=Fair Value Change, if negative] Credit Other Comprehensive Income [Amount=Fair value change, if negative]
   At Exercise Date or Expiration Date
Debit Stock Option−Fair Value [Amount=amount in account]
   Credit Accumulated other Comprehensive Income [Amount=amount in account]
Note that no entries are made to Earnings or Cash.
   Please see Part II below for the accounting for the STRIKE PRICE of the Stock Option and the related treatments of CASH, Common Stock and Other Comprehensive Income accounts.
      Part II

Table to Demonstrate Alternative Accounting Model

Example: A stock option contract is with a strike price of 10, vesting in two years, at a time when the market price of the stock is 12.

The market value of the stock option is X where X=the sum of the Time Value of the option and the Intrinsic Value of the option.

The Fair Value of the option for accounting purposes is always equal to the Intrinsic Value.

The Intrinsic Value is never negative, always zero if the stock option contract cannot be exercised and the difference between the stock price and 10, the exercise price, when the stock price is greater than 10.
1. At the granting of the stock option contract (keeping in mind that ZERO is a place holder of economic substance and of value for internal control purposes)
   Debit Other Comprehensive Income 0
      Credit Stock Options (an Equity account) 0
2. On any day after the grant date up to the vesting date (the date the stock options can first be exercised)
   No entry needed for changes in Intrinsic Value.
3. As of the vesting date, when the stock option contract can be exercised, at any time when
   A. the stock option is “out of the money” (stock price is equal to or less than 10, the strike price)
      No entry needed.
   B. the stock option is in the money (stock price, 12, is above 10, the strike price)
      Debit Other Comprehensive Income 10
         Credit Stock Options 10
            This entry shows a short derivative position and a loss in OCI
4. The stock options are exercised and the company receives $10 dollars and issues $12 worth of stock
   a. Debit Cash 10
      Credit Common Stock 10
This entry correctly shows the issuance of Common Stock and actual Cash raised. Without material modification to the company's accounts the Capital Paid in Surplus account incorporates the $2 foregone cash receipt, the difference between the market price and the strike price.
   b. And to clear out the stock options which no longer exist
      Debit Stock options 10
         Credit Accumulated Other Comprehensive Income 10
            This entry shows both the elimination of the stock option account and the recovery of economic profit
            Modified Example where the Stock Options are treated as an economic hedged of an existing position in Treasury shares. The Treasury shares are normally carried at cost as a reduction of Equity. As of the vesting date they are marked to market pursuant to the effective economic hedge.
5. At the granting of the stock option contract (keeping in mind that ZERO is a place holder of economic substance and of value for internal control purposes)
   Debit Other Comprehensive Income 0
      Credit Stock Options (an Equity account) 0
6. On any day after the grant date up to the vesting date (the date the stock options can first be exercised)
   No entry needed for changes in Intrinsic Value.
7. As of the vesting date, when the stock option contract can be exercised, at any time when
a. the stock option is “out of the money” (stock price is equal to or less than 10, the strike price)
   No entry needed.
   b. the stock option is in the money (stock price, 12, is above 10, the strike price)
      Debit Other Comprehensive Income 10
         Credit Stock Options 10
            This entry shows a short derivative position and a loss in OC indicative of the dilutive effects of the stock options if exercised.
c. Mark the Treasury stock to market (assume a historic cost of 5, and market price of 12 or mark to market of 7)
   Debit Treasury stock—mark to market 7
      Credit Other Comprehensive Income 7
         This marks-to-market the value of the Treasury stock and records economic income of 7.

The net result in OCI of the mark to market of the stock option, and the Treasury stock that will be distributed, is 3:

| | |
|---|---|
| Value of Shares | 12 |
| Acquisition cost of Treasury Shares 5 | |
| Foregone Profits on stock options 2 | 7 |
| Net Cash inflow to the firm | 5 |

8. The stock options are exercised and the company receives $10 dollars and issues $12 worth of stock
   a. Debit Cash 10
      Debit Other Comprehensive Income 2
         Credit Treasury Stock (at their carrying value) 12
This entry correctly shows the issuance of Treasury Shares at market value and actual Cash raised.
   b. And to clear out the stock options which no longer exist
Debit Stock options 10
   Credit Accumulated Other Comprehensive Income 10
This entry shows both the elimination of the stock option account and the recovery of economic profit
   c. And to clear out the remaining Accumulated Other Comprehensive Income entry to Common Stock
Debit Accumulated Other Comprehensive Income 5
   Credit Common Stock 5

At the end of the transaction cycle no balance should remain in Other Comprehensive

Income. The surplus raised on the hedged Treasury stock position upon the exercise of the stock options should be reflected in Common Stock.

### III. EXAMPLES

The following is an exemplary illustration of the application of accounting for Stock Options according to an aspect of the present invention.

| Copyright © 2005 Louis P Le Guyader and | | |
|---|---|---|
| Le Guyader & Co. Ltd. All rights reserved. | | At Grant Date |
| CASE TYPE | Examples Notes | Case A1 |
| Case Facts 1 - Time of Valuation | | Grant |
| | | Date |
| Case Facts 2 - Exercisable Legally (vested) Yes = 1, No = 0 | | 0 |
| Case Facts 3 - Strike Price - INPUT FROM OPTION CONTRACT | 10 | 10 |
| Case Facts 4 - Market Price - INPUT FROM MARKET | Market | 12 |
| Mathematical Intrinsic Value subject to minimum of ZERO | | 2 |
| Case Facts 5 - Exercisable (economically) Yes 1, No, 0 | | 1 |
| Exercisable under two conditions YES = 1, No = 0 | | 0 |
| Intrinsic Value for Reporting (all Fair Value choices) | | 0 |
| TIME CLOCK | (X, Y) | |
| X = If Grant Date 0, Otherwise 1 | | 0 |
| Y = If Exercise Date 1, Otherwise 0 | | 0 |
| check carefully the accounting policy decisions | | |
| ACCOUNTING POLICY FROM SCENARIO NUMBER | | inset |
| Activate Reporting of Strike Price; Yes = 1, NO = 0 | CHANGE | 1 |
| Step 1: Case Facts 2 | | |
| Documentation Reference | | |
| Contract Number | Dummy | xxx |
| Employer ID Data (SSN) | Dummy | SSN |
| Number of SEC Issuer Shares | 1 | 1 |
| Option Terms - shown on a per share basis | | |
| Underlying - Common Stock of SEC Issuer CUSIP # | Dummy | CUSIP # |
| Contract Term (years from inception to termination) | Live Manual Input | 5 |
| Nonexercisble term (years from inception to vesting date) | Live Manual Input | 2 |
| Exercisable Term (years from vesting to termination date) | Calculated | 3 |
| Year of Calculation (1 if exercisable, 0 if not); | Live Manual Input | 0 |
| in this case 1 if year 3, 4, 5 and 0 if Year 1, 2. | | |
| Strike Price (or Exercise Price) | Live Manual Input | 10 |
| Market Price | Live Market Feed | 12 |
| Interest Rate - for Option Valuation | Dummy | 0.05 |
| Interest Rate - for discounting if “forward short option” | Dummy | 0.05 |
| method is used | | |
| Volatility of Stock for Valuation | Dummy | 0.35 |
| Probability Parameters (if Binomial Option Model) | Dummy | Input Field 1 |
| Type of Contract: European or American | Default | American |
| Valuation Model used Insert through add-in features) | Dummy | Modified Black Scholes with Merton |
| Select Fair Value mode: Price taken from external valuation or Calculated | Illustration | Taken |
| Intrinsic Value − Raw Value (market Price − Strike Price) | Calculated | 2 |
| Intrinsic Value Set to Minimum Value of ZERO Step 1 | Calculated | 2 |
| Intrinsic Value Set to Minimum Value of ZERO Step 2 | Calculated | 0 |
| Intrinsic Value for Reporting Purposes | Calculated | 0 |
| Fair Value (as calculated, or input) RAW VALUE | Illustration | 6 |
| Fair value (minimum value set to zero) | Calculated | 6 |
| Fair Value For Reporting Purposes | Calculated | 6 |
| Time Value = [Fair Value − Intrinsic Value] Raw Value | Calculated | 6 |
| Time Value Reporting Accounting Method [1 if Time value is | | 1 |
| not reportable and 0 if Time Value is reportable | | |
| Time Value Filter Step 1 | Calculated | 6 |
| Time Value Filter Step 2 | Calculated | 6 |
| Time Value for Reporting Purposes | | 6 |
| Derivative Valuation Recap Table | | Grant Date |
| Share Price | | 12 |

### V. CONCLUSION

The present invention provides the ability for stock options to be accounted for using, e.g., Intrinsic Value as the fair value and Other Comprehensive Income, rather than Earnings. Stock options are to be treated as a derivative hedging Treasury Stock under the special hedge accounting rules. This treatment is efficiently auditable, as only three variables need be identified by the auditor:
Number of shares;
Strike price; and
Market price.

A. Valuation:

The necessary and sufficient accounting variable for the accounting for stock options is the variable “Intrinsic Value”.

This is a subset of the value of any stock option contract as derived from market prices or a model. This choice is superior to a fair value based on market prices (which in most cases are unobservable, as stock option contracts do not trade), and valuations using the Black Scholes or binomial option pricing models as the assumptions on which these models are based are often not honored or the input variables are not easily subject to verification and audit.

B. Accounting Methodology:

Stock options are to be marked-to-market on the Equity portion of the Balance Sheet, as stock options are Equity instruments. The changes in market value, which will be changes in intrinsic value, are to be posted to Other Comprehensive Income.

C. Hedging Election:

Stock options are to be treated as a derivative in a linked transaction hedging Treasury Shares. The linked pair are to be accounted for under special hedge accounting with marks-to-market recorded in Other Comprehensive Income only.

Overall, the process of the present invention provides the ability to perform the following:
record stock options on a Balance sheet with an offset to Other Comprehensive Income (the value used is (required) Intrinsic Value and (by choice) either or both of the Time Value and the Strike Value (as defined)
update the Carrying Amount of the stock options at every reporting period
record the Strike Value of the stock options on the Balance Sheet with an offset to

Other Comprehensive Income, wherein the Comprehensive Value of the stock options for Balance Sheet purposes is comprised of the sum of the Strike Value, the Time Value and the Intrinsic Value of the stock options
categorize all activity in stock options through Other Comprehensive Income except where by choice the offset for the Strike Value is a Contingent Receivable (Asset) account.
present Treasury shares and stock options as components of equity, wherein when
the amount of Treasury Shares is equivalent to Stocks subject to stock options granted,
further comprising the step of reducing the accounting variable for the stock options to
the Intrinsic Value of the stock option, wherein the Intrinsic Value=stock price less exercise price, subject to a minimum of zero.
require the marking-to-market (i.e., updating) of both stock options and the hedged item (the Treasury shares) in the Equity portion on the Balance Sheet, with the mark going through Other Comprehensive Income.
use Intrinsic Value as the fair value
use Other Comprehensive Income, rather than Earnings.
treat stock options as a derivative hedging Treasury Stock under the special hedge accounting rules.
select whether to carry the Strike Value as a constant (whether zero of the Strike Value incorporated in the Stock Option) or allow if to vary with its account measure taking on one of two values only (zero or the Strike Value). The Strike Value can never be negative.
Permit choice as to whether the accounts used for the Carrying Values of the derivative are treated as Equity or Liability accounts
Removal of all ESO accounts and their values from the financial statements if the ESOs expire unexercised (“mandatory reversal”)
   As a matter of quality control this invention also includes the following error reduction mechanisms:
blocking of certain accounts, or forcing their values to zero, if the accounting choice should not permit the account to be used
a logic test to confirm that “debits equal credits” and that “assets=liabilities+equity”
allocation tools to match sign convention to debit and credit convention.
in some instances the use of “ZERO” keeps the account in financial statement presentation (as opposed to eliminating it) as that value may become nonzero in the future

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims.

1. A system for performing a stock option valuation utilizing a processing element which comprises:
creating an account on a balance sheet to store values associated with said stock option valuation; and
performing one or more of the following steps:
posting future expected strike price on the balance sheet pursuant to the terms of the employee's contract granting the stock option;
estimating the fair value of the stock option on the balance sheet by discounting the time value of said stock option;
expensing the fair value of the stock option on the balance sheet under Other Comprehensive Income (OCI); and
periodically marking-to-market the carrying fair value of the stock option on the balance sheet.

2. The system of claim 1, wherein said step of creating an account comprising creating an electronic account.

3. The system of claim 1, wherein said posting step further includes recognizing fair market value on the balance sheet in addition to future expected strike price.

4. The system of claim 3, wherein an intrinsic value of the stock option is utilized as a measure of the fair market value of the stock option.

5. The system of claim 1, wherein said estimating step includes using an intrinsic value of the stock option as a measure of the fair value of the stock option.

6. The system of claim 5, wherein said periodically marking-to-market step comprises periodically marking-to-market the carrying intrinsic value of the stock option.

7. The system of claim 1, wherein said estimating step includes estimating the fair value of the stock option by discounting the time value of the stock option.

8. The system of claim 1, wherein the processing element comprises a computer-readable storage medium having computer executable code portions stored therein for performing the method.

9. The system of claim 1, wherein said posting step comprises writing a record to the computer readable storage medium.

10. The system of claim 1, wherein said estimating step comprises writing a record to the computer readable storage medium.

11. The system of claim 1, wherein said expensing step comprises writing a record to the computer readable storage medium.

12. The system of claim 1, wherein said periodically marking-to-market step comprises writing a record to the computer readable storage medium.

13. A program storage device readable by a machine, tangibly embodying a program of instructions executable by the machine to perform method steps for performing stock option valuation, the method comprising the steps of:
creating an account on a balance sheet to store values associated with said stock option valuation; and
performing at least one of the following steps:
posting future expected strike price on the balance sheet pursuant to the terms of the employee's contract granting the stock option;
estimating the fair value of the stock option on the balance sheet by discounting the time value of said stock option;
expensing the fair value of the stock option on the balance sheet under Other Comprehensive Income (OCI); and
periodically marking-to-market the carrying fair value of the stock option on the balance sheet.

14. The program storage device of claim 13, wherein said step of creating an account comprising creating an electronic account.

15. The program storage device of claim 13, wherein said posting step further includes recognizing fair market value on the balance sheet in addition to future expected strike price.

16. The program storage device of claim 15, wherein an intrinsic value of the stock option is utilized as a measure of the fair market value of the stock option.

17. The program storage device of claim 13, wherein said estimating step includes using an intrinsic value of the stock option as a measure of the fair value of the stock option.

18. The program storage device of claim 17, wherein said periodically marking-to-market step comprises periodically marking-to-market the carrying intrinsic value of the stock option.

19. The program storage device of claim 13, wherein said estimating step includes estimating the fair value of the stock option by discounting the time value of the stock option.

20. The program storage device of claim 13, wherein said posting step comprises writing a record to the program storage device.

22. The program storage device of claim 13, wherein said estimating step comprises writing a record to the program storage device.

23. The program storage device of claim 13, wherein said expensing step comprises writing a record to the program storage device.

24. The system of claim 13, wherein said periodically marking-to-market step comprises writing a record to the program storage device.
